(19) United States
(12) Patent Application Publication
(10) Pub. No.: US 2009/0193344 A1
(43) Pub. Date: Jul. 30, 2009

(54) COMMUNITY MOOD REPRESENTATION

(75) Inventor: Scott Smyers, Los Gatos, CA (US)

Correspondence Address: Trellis Intellectual Property Law Group, PC, 1900 EMBARCADERO ROAD, SUITE 109, PALO ALTO, CA, 94303, US

(73) Assignees: SONY CORPORATION, Tokyo (JP); SONY ELECTRONICS INC., Parkridge, NJ (US)

(21) Appl. No.: 12/019,001

(22) Filed: Jan. 24, 2008

(51) Int. Cl. G06F 3/048

(52) U.S. Cl. 715/753

(57) ABSTRACT

In one embodiment, a method for determining a community mood can include: receiving a plurality of user inputs for determining individual user moods within a community; aggregating the individual user moods to form an aggregated community mood; selecting a community mood representation corresponding to the aggregated community mood; and displaying the selected community mood representation to the community.

### BACKGROUND

Ratings websites on the Internet allow users to rate events or products, and such ratings can be tabulated or averaged for use, e.g., by a product manufacturer or promoter. Also, pollsters can analyze various posts in opinion type forums for obtaining relevant public opinion data. In addition, social networking websites allow for users to enter personal mood indications on their own web pages.

### SUMMARY

In one embodiment, a method for determining a community mood can include: receiving a plurality of user inputs for determining individual user moods within a community; aggregating the individual user moods to form an aggregated community mood; selecting a community mood representation corresponding to the aggregated community mood; and displaying the selected community mood representation to the community.

A further understanding of the nature and the advantages of particular embodiments disclosed herein may be realized by reference to the remaining portions of the specification and the attached drawings.

### BRIEF DESCRIPTION OF THE DRAWINGS

FIG. 1 illustrates an example community mood representation system in accordance with embodiments of the present invention.

FIG. 2 illustrates an example individual user mood indicator generation in accordance with embodiments of the present invention.

FIG. 3 illustrates an example user mood entry interface in accordance with embodiments of the present invention.

FIG. 4 illustrates an example consolidated mood determination in accordance with embodiments of the present invention.

FIG. 5 illustrates a flow diagram of an example method of providing a consolidated community mood indication in accordance with embodiments of the present invention.

### DETAILED DESCRIPTION OF EMBODIMENTS

Particular embodiments offer an approach for gauging and representing a consolidated mood of a community (e.g., an online or web-based community) of people, and including “mood input” or “mood gathering” devices and techniques. For example, a hand-operated “mood gauge” for individual participants in the community group may be used to input a mood interactively. Such a mood gauge can include a multidimensional input device to allow signaling of mood along multiple axes (e.g., energy versus lethargy, interest versus apathy, anger versus glee, happiness versus sadness, etc.). Alternatively or in addition, a mood gathering technique may include automated examination of an individual's verbal or text contributions to a community discussion by assessing words, phrases, or sentence construction, to determine mood. Mood information gathered can be aggregated and consolidated, with the consolidated mood information being presented to all members of the community. Such a mood presentation or representation may include weather icons (e.g., sunny or rainy) and/or computer-generated facial expressions for communicating the consolidated community mood to its members.

For example, a general or collective mood on an online community discussion board may be negative, and particular embodiments can allow for a determination of such a negative mood, as well as the generation of a graphical reflection of that mood (e.g., a sad face icon). Thus, particular embodiments can include a mood information gathering technique for a group of users, and a collective mood representation determined therefrom. In gathering individual mood information, text from online postings may be analyzed, facial recognition of a user can be performed (e.g., to determine a sad or a happy face), or other text or verbal inputs, etc., can be used. A consolidated community mood or a collective feeling of multiple users can then be represented with one or more icons for presentation to the community.

A user can also explicitly enter mood (e.g., when posting with a happy or unhappy indication), such as by using a mood lever or slider bar with various axes (e.g., similar to a game setting entry device). Also, sentence construction or particular words (e.g., tags on a given posting) can be used to determine if the person is happy, sad, or in any other mood suitable for conveyance. Facial recognition of common expressions may also be utilized to determine a person's mood. Also, the automated examination of text and/or voice comments within a particular discussion group can be utilized. Such a consolidated community mood may also be used for purchasing or product marketing decisions in some applications. Thus, particular embodiments can include a variety of ways of gathering new information, consolidating such information into a community mood indication, and presenting this community mood indication to the online community.

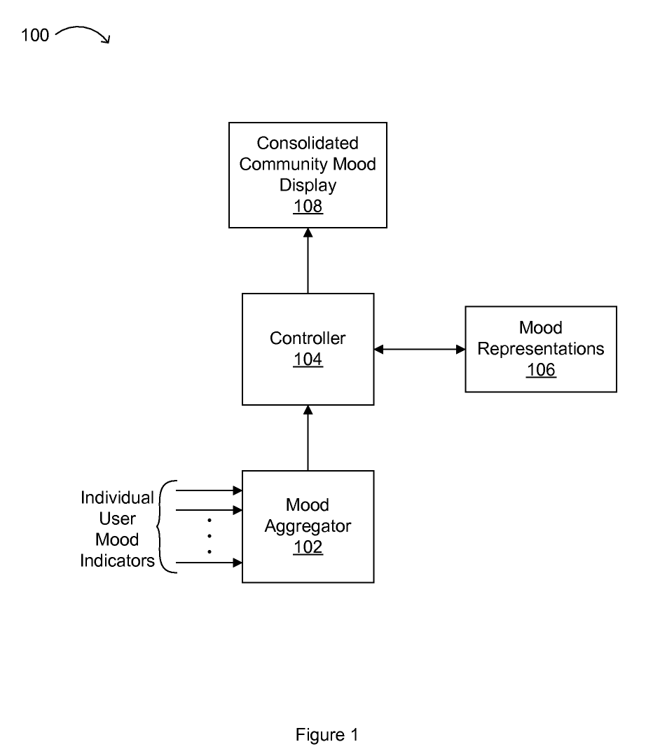

FIG. 1 shows an example community mood representation system 100 in accordance with embodiments of the present invention. Individual user mood indicators can be received in mood aggregator 102. For example, individual user mood indicators can be derived from explicit text (e.g., by identifying certain key words, or analyzing sentences, etc.), and may be aggregated in mood aggregator 102 for outputting an aggregated mood to controller 104. Various mood representations or icons 106, such as smiley faces or sunshine symbols for a happy mood can then be accessed and applied for a community mood display. For example, controller 104 can send an appropriate mood representation 106 to consolidated community mood display 108.

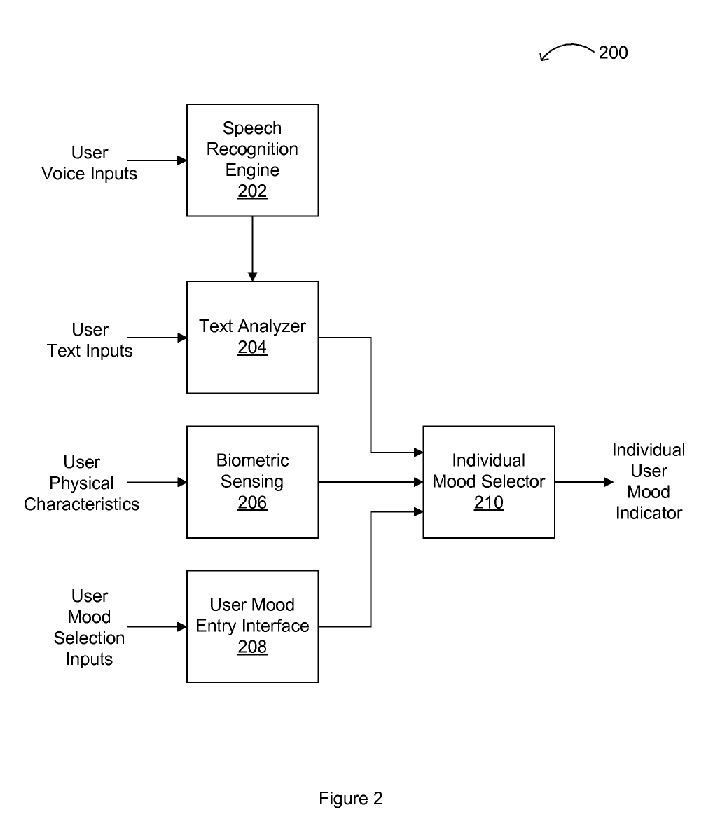

FIG. 2 shows an example individual user mood indicator generation 200 in accordance with embodiments of the present invention. Several different types of user inputs can be utilized in determining a mood of a particular individual. For example, user voice inputs can be received in speech recognition engine 202, an output of which can be sent to text analyzer 204. Text analyzer 204 can also receive explicit user text inputs (e.g., from a text posting in a discussion forum of a particular online community), and may analyze words, phrases, sentence structures, sentences, etc., in order to determine a particular person's mood.

Also, biometric sensing 206 can receive user physical characteristics for determining a mood, and may include facial characteristic analysis using facial recognition technology, analysis of touch-based biometric information (e.g., determining sweat content from a finger swipe device), or the like. Finally, a user can simply explicitly convey a mood via user mood entry interface 208. Individual mood selector 210 can receive inputs from the individual mood determining blocks (e.g., text analyzer 204, biometric sensing 206, user mood entry interface 208, etc.), and may provide an individual user mood indicator to mood aggregator 102. In this fashion, individual moods for a plurality of online community members can be collected.

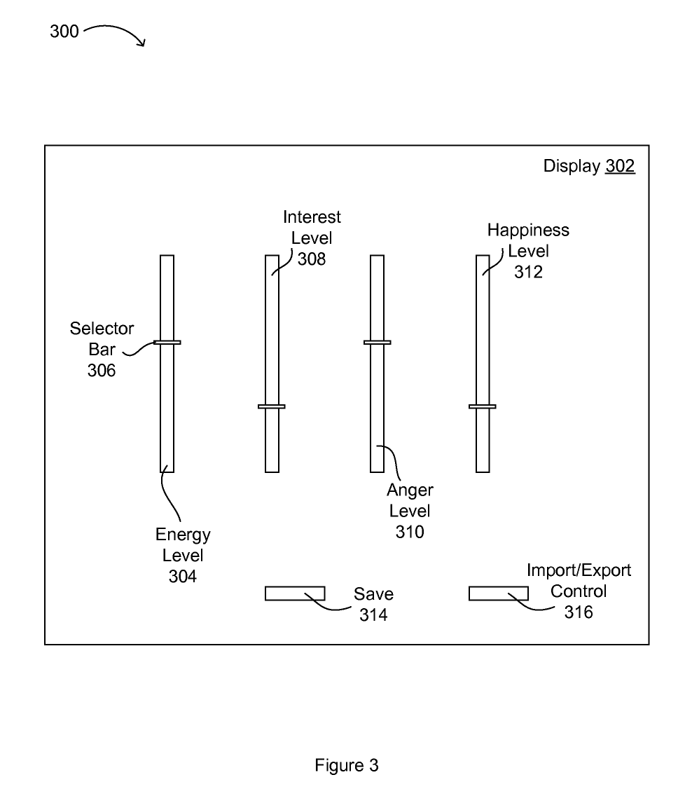

FIG. 3 shows an example user mood entry interface 300 in accordance with embodiments of the present invention. The user interface can be seen on display 302, and may include any number of adjustable controls. For example, energy level 304 can select between degrees of energy versus lethargy using selector bar 306. Also, interest level 308 can use a selector bar for choosing degrees of interest versus apathy, anger level 310 can be used for selection of degrees of anger versus glee, and happiness level 312 can be used to input of a degree of happiness versus sadness. Further, any suitable number of dimensions or types of mood characteristics can be used in a customizable user interface.

Depending on the purpose of the community, different characteristics may be more or less relevant. For example, a knitting community might have one set of dimensions or types of mood characteristics that the community itself chooses, whereas a soccer fan club will likely have different dimensions or types of mood characteristics that they themselves create and evolve over time. In addition, save button 314 can be used to save a user's mood input. Also, import/export control 316 can be used to import a mood from another tool, or to export the mood to another tool. For example, a mood of a community through time may be exported in some machine-readable form such that the mood can be correlated with a contemporaneous occurrence (e.g., the mood of a soccer crowd during each play of a game).

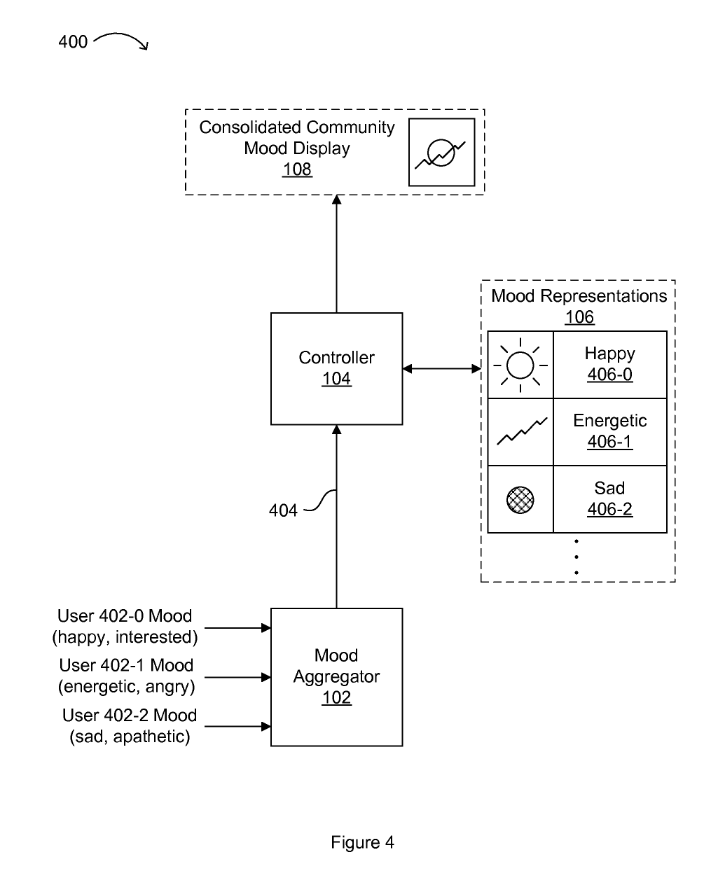

FIG. 4 shows an example consolidated mood determination 400 in accordance with embodiments of the present invention. Mood aggregator 102 can receive any number of individual user mood indicators. For example, a mood indicator for user 402-0 can convey a mood of happy and interested, a mood indicator for user 402-1 can convey a mood of energetic and angry, and a mood indicator for user 402-2 can convey a mood of sad and apathetic. Mood aggregator 102 can then provide aggregated mood signal 404 to controller 104. For example, aggregated mood signal 404 may be a binary string signal (e.g., an 8-bit wide signal), carrying enough information for selection of an appropriate mood representation 106. Particular embodiments can perform an average or a weighted average, such as where a mood of members of the community who participate more regularly, or who are deemed by the community to be somehow more “important” in some way, may be weighted higher than the mood of members of the community who participate less frequently or are in some other way deemed by the community to be less “important.”

Controller 104 can utilize aggregated mood signal 404 to search mood representations 106 for a most appropriate consolidated mood representation. For example, mood representations 106 can include a bright sun display corresponding to a happy mood 406-0, upward mountainous trend lines corresponding to an energetic mood 406-1, and a cross-hatched circle corresponding to a sad mood 406-2. Other mood representations 106, such as various combinations or degree representations of various stronger moods, can also be included in mood representations 106. Controller 104 can select the best mood representation (e.g., by using a binary index or address value from aggregated mood signal 404), and may provide such a representation for consolidated community mood display 108. This mood display can then be conveyed to members of the particular community (e.g., users 402-0, 402-1, 402-2, etc.).

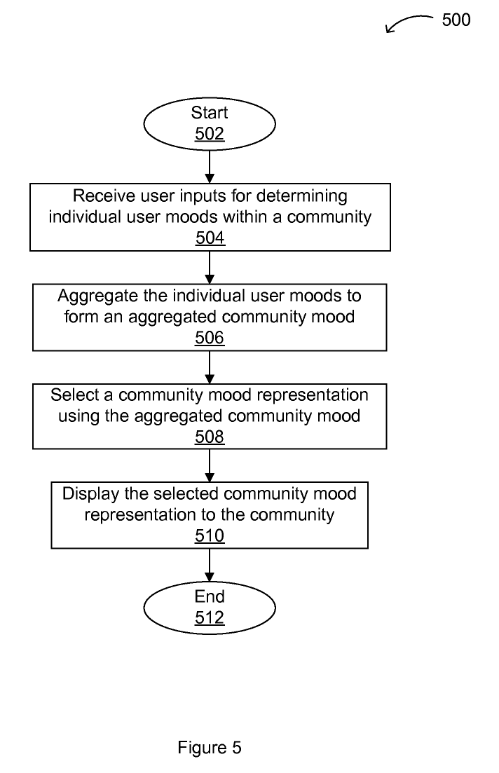

FIG. 5 shows a flow diagram of an example method of providing a consolidated community mood indication 500 in accordance with embodiments of the present invention. The flow can begin (502), and user inputs can be received for determining individual user moods within a community (504). For example, speech recognition can be utilized, as well as text analysis, biometric sensing, explicit user mood entry, or any other suitable mood determination approach. The individual user moods can then be aggregated to form an aggregated community mood (506). Here, summation, averaging, and/or any other suitable form of aggregation or the like can be performed.

A community mood representation can then be selected using the aggregated community mood (508). For example, a binary index or other addressing format can be utilized for selection of a stored mood representation. The selected community mood representation can then be displayed for the given community (510), completing the flow (512). For example, such a display can include a predetermined icon, symbol, or combination thereof. Further, the display can be made to the community members in any suitable form, such as via location in a prominent place on a community website.

In another embodiment, a degree of engagement of each community member can be tracked to increase or decrease the relevance of a measured mood. For example, if a member of the community receives a phone call that is not related to the particular community activity, or if a community member starts surfing the Internet or in some other way “disengages” from a community activity, then the measured mood of that participant may be weighted lower or eliminated in the aggregation of the community mood algorithm. For example, one can create a mood dimensions editor tool to allow community members to define and alter the dimensions of mood that are pertinent to a particular community.

Although the description has been described with respect to particular embodiments thereof, these particular embodiments are merely illustrative, and not restrictive. For example, while particular types of individual mood determination have been described, any other suitable approach for determining mood can be used. Also, while specific types of moods have been described (e.g., in a user interface), any suitable types of moods and/or ways of inputting those moods can also be accommodated in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of determining a consolidated community mood, comprising:
receiving a plurality of user inputs for determining individual user moods within a community;
aggregating the individual user moods to form an aggregated community mood;
selecting a community mood representation corresponding to the aggregated community mood; and
displaying the selected community mood representation to the community.

2. The method of claim 1, wherein the determining the individual user moods comprises receiving user voice inputs in a speech recognition engine.

3. The method of claim 1, wherein the determining the individual user moods comprises analyzing user text.

4. The method of claim 1, wherein the determining the individual user moods comprises biometrically sensing user physical characteristics.

5. The method of claim 1, wherein the determining the individual user moods comprises explicitly receiving a user mood using a user interface.

6. The method of claim 5, wherein the user interface comprises an energy level selection.

7. The method of claim 5, wherein the user interface comprises an interest level selection.

8. The method of claim 5, wherein the user interface comprises an anger level selection.

9. The method of claim 5, wherein the user interface comprises a happiness level selection.

10. An apparatus, comprising:
one or more processors; and
logic encoded in one or more tangible media for execution by the one or more processors, and when executed operable to:
receive a plurality of user inputs for determination of individual user moods within a community;
aggregate the individual user moods to form an aggregated community mood;
select a community mood representation corresponding to the aggregated community mood; and
display the selected community mood representation to the community.

11. The apparatus of claim 10, wherein the aggregated community mood comprises a binary string signal.

12. The method of claim 10, wherein the determination of the individual user moods comprises translating user voice inputs with a speech recognition engine.

13. The apparatus of claim 10, wherein the determination of the individual user moods comprises a text analysis of user text.

14. The apparatus of claim 10, wherein the determination of the individual user moods comprises a biometric sensing of user physical characteristics.

15. The apparatus of claim 10, wherein the determination of the individual user moods comprises use of a user interface for explicit mood entry.

16. The apparatus of claim 15, wherein the user interface comprises an energy level selector.

17. The apparatus of claim 15, wherein the user interface comprises an interest level selector.

18. The apparatus of claim 15, wherein the user interface comprises an anger level selector.

19. The apparatus of claim 15, wherein the user interface comprises a happiness level selector.

20. A community mood determination system, comprising:
means for receiving a plurality of user inputs for determining individual user moods within a community;
means for aggregating the individual user moods to form an aggregated community mood;
means for selecting a community mood representation corresponding to the aggregated community mood; and
means for displaying the selected community mood representation to the community.
